(19) United States
(12) Patent Application Publication
(10) Pub. No.: US 2026/0016035 A1
(43) Pub. Date: Jan. 15, 2026

(54) Head for Doghouse

(71) Applicant: Illinois Tool Works Inc., Glenview, IL (US)

(72) Inventor: Mark O. Lepper, Oak Park, IL (US)

(21) Appl. No.: 19/263,932

(22) Filed: Jul. 9, 2025

Related U.S. Application Data
(60) Provisional application No. 63/671,365, filed on Jul. 15, 2024.
(60) Provisional application No. 63/739,719, filed on Dec. 30, 2024.

(51) Int. Cl. F16B 5/06

(52) U.S. Cl. CPC F16B 5/0657; F16B 5/065

(57) ABSTRACT

A doghouse fastener assembly is provided for connecting two components together with adjustable spacing. The assembly includes a doghouse feature on the first component, formed by sidewalls and a bottom wall to create a pocket. A fastener has a retention portion that attaches to the second component and a doghouse head that fits into the doghouse pocket. The doghouse head includes two plates connected by a neck, creating a gap between them. Depending on how the fastener is inserted into the pocket—either in a first or second orientation—the spacing between the two components can be adjusted, allowing for two different installed heights using the same fastener.

### CROSS-REFERENCE

The present application claims priority to U.S. Provisional Patent Application No. 63/671,365, filed Jul. 15, 2024, and No. 63/739,719, filed Dec. 30, 2024, and entitled “Head for Doghouse,” which are hereby incorporated by reference.

### BACKGROUND

Automotive components require fastening techniques that are not only simple to manufacture and assemble but also highly reliable and efficient. Components must often be joined in a manner that is not only structurally sound but also cost-effective and suitable for high-volume manufacturing. Fasteners are commonly used to attach secondary panels, trim pieces, or brackets to primary structural panels.

These assemblies must accommodate variations in design, tolerances, and installation requirements while maintaining secure and consistent connections. In many cases, different applications require different spacing between components to accommodate design or functional constraints. Traditionally, this has necessitated the use of multiple fastener types or additional hardware, which increases part count, complicates assembly, and raises manufacturing costs.

Therefore, there is a need for a fastener that can provide different component spacing configurations based solely on its installation orientation, thereby simplifying inventory management and streamlining the assembly process.

### SUMMARY

The present disclosure relates generally to a fastening system and fastener to form a connection between components, such as automotive panels, substantially as illustrated by and described in connection with at least one of the figures, as set forth more completely in the claims. More specifically, the present disclosure provides, in one example, a fastener with a doghouse head that can provide different component spacing configurations based solely on its installation orientation.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate, respectively, disassembled and assembled side views of an example fastening system configured to form a connection between components in accordance with aspects of this disclosure.

FIGS. 1c and 1d illustrate, respectively, disassembled and assembled underside isometric views of the fastening system.

FIGS. 2a and 2b illustrate, respectively, side elevational and side cross sectional views of the fastening system in a first installed orientation to provide a first spacing (D₁).

FIGS. 2c and 2d illustrate, respectively, side elevational and side cross sectional views of the fastening system in a second installed orientation to provide a second spacing (D₂).

FIG. 3a illustrates a top-side isometric view of the first component with a doghouse feature.

FIG. 3b illustrates an underside isometric view of the first component with the doghouse feature.

FIG. 3c illustrates a top plan view of the first component.

FIG. 3d illustrates a bottom plan view of the first component.

FIGS. 3e through 3h illustrate first, second, third, and fourth elevational side views of the first component.

FIG. 3i illustrates an enlarged side view of the first component at Detail A (FIG. 3e).

FIG. 3j illustrates a cross-sectional view of the first component taken along cut line A-A (FIG. 3e).

FIG. 4a illustrates a topside isometric view of the doghouse fastener.

FIG. 4b illustrates an underside isometric view of the doghouse fastener.

FIG. 4c illustrates a top plan view of the doghouse fastener.

FIG. 4d illustrates a bottom plan view of the doghouse fastener.

FIGS. 4e through 4h illustrate first, second, third, and fourth elevational side views of the doghouse fastener.

FIG. 4i illustrates a cross-sectional view of the doghouse fastener taken along cut line B-B (FIG. 4e).

FIGS. 5a through 5g illustrate additional fastener styles for coupling with the component in accordance with other aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener can be used to form a connection between a first component and a second component, such as automotive panels. The disclosed fastener provides a fastener with a doghouse head that can provide different component spacing configurations based on its installation orientation.

In one example, a doghouse fastener for forming a connection between a first component having a doghouse feature and a second component comprises: a retention portion configured to engage the second component; and a doghouse head integrally formed with the retention portion and configured to slide into the doghouse feature along an axis to assume selectively one of: a first installed orientation to provide a first spacing between the first component and the second component; and a second installed orientation to provide a second spacing between the first component and the second component, wherein the doghouse head comprises a first plate connected to a second plate by a neck to define a gap between the first plate and the second plate.

In another example, a doghouse fastener assembly for forming a connection between a first component and a second component comprises: a doghouse feature associated with the first component, wherein the doghouse feature comprises a set of sidewalls bridged by a bottom wall to define a pocket; and a doghouse fastener having a retention portion configured to engage the second component and a doghouse head integrally formed with the retention portion and configured to engage the doghouse feature, wherein the doghouse head comprises a first plate connected to a second plate by a neck to define a gap between the first plate and the second plate, and wherein the doghouse head is configured to slide along an axis and into the pocket selectively in one of: a first installed orientation to provide a first spacing between the first component and the second component; and a second installed orientation to provide a second spacing between the first component and the second component.

In some examples, at least one the first plate and the second plate are geometrically asymmetric along a lateral axis.

In some examples, the doghouse head comprises a primary insertion surface associated with the first installed orientation and a secondary insertion surface associated with the second installed orientation, wherein the primary insertion surface and the secondary insertion surface are positioned on opposite sides of the doghouse head.

In some examples, inserting the primary insertion surface first into the doghouse feature results in the first installed orientation, and inserting the secondary insertion surface first into the doghouse feature results in the second installed orientation.

In some examples, doghouse head is rotated about its center axis to alternate between the first installed orientation and the second installed orientation.

In some examples, the neck is offset relative to the first plate and centered relative to the second plate.

In some examples, at least one of the first plate and the second plate comprises at least one alignment head channel and at least one alignment head rail configured to interface with at least one alignment channel and at least one alignment rail associated with the doghouse feature.

In some examples, the at least one alignment head channel is configured to receive the at least one alignment rail when in the first installed orientation.

In some examples, the at least one alignment head rail is configured to abut the at least one alignment rail when in the second installed orientation.

In some examples, the first plate and/or the second plate comprises one or more visual orientation indicators to identify the primary insertion surface or the secondary insertion surface.

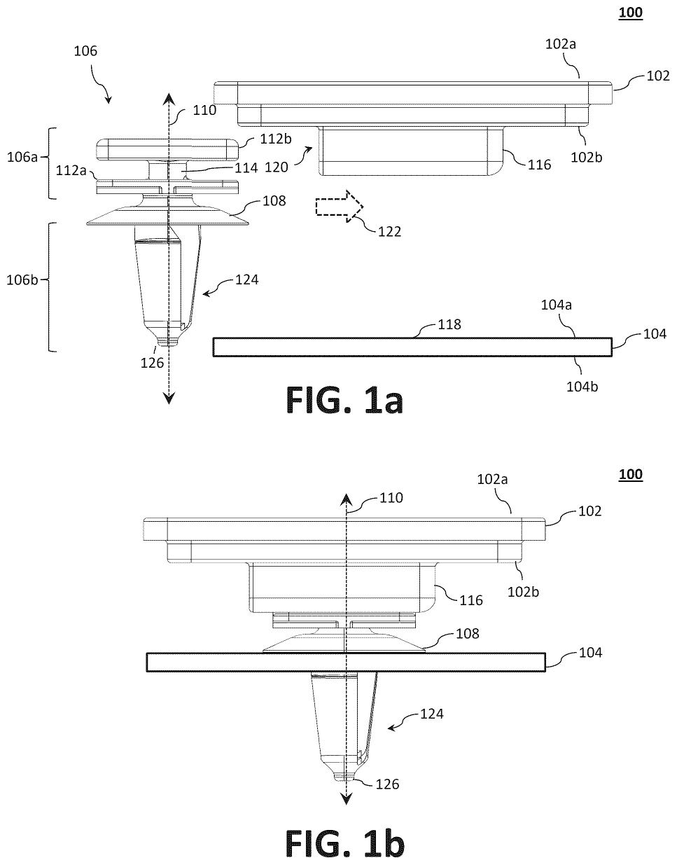

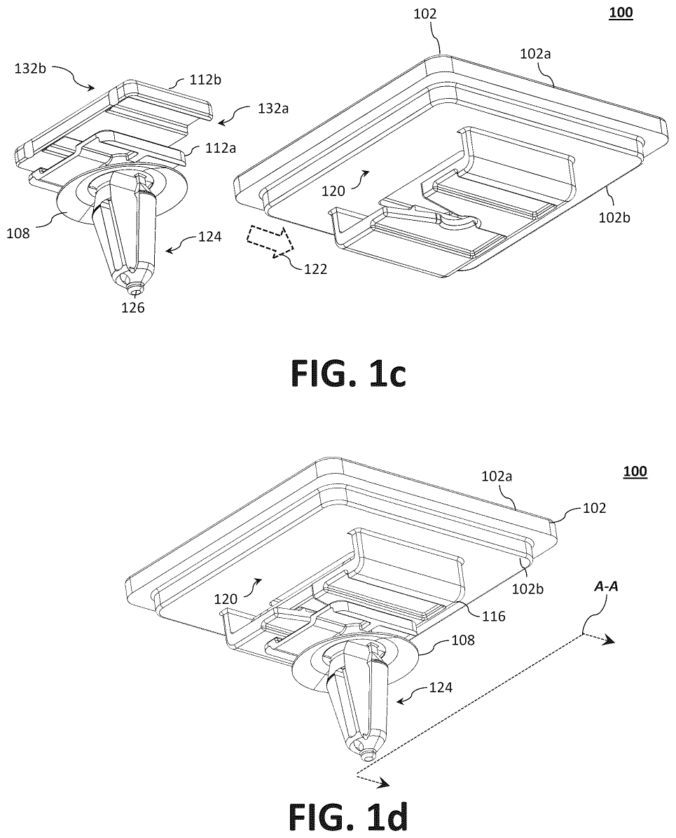

FIGS. 1a and 1b illustrate, respectively, disassembled and assembled side views of an example fastening system 100 configured to form a connection between a first component 102 102 and a second component 104 in accordance with aspects of this disclosure. FIGS. 1c and 1d illustrate, respectively, disassembled and assembled underside isometric views of the fastening system 100. The first component 102 and the second component 104 may be, for example, automotive panels. Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 102 include, without limitation, door trim panels, moldings, trim pieces, and other substrates (whether used as interior or exterior surfaces).

In operation, the installer selects the desired spacing: either the first spacing (D1) or the second spacing (D2). The doghouse head 106a is rotated about the center axis 110 to the corresponding orientation. The doghouse head 106a is inserted into the doghouse feature 116 through a linear sliding motion in direction of arrow 122, guided by the geometry features of doghouse head 106a and the doghouse feature 116. The fastener portion 106b is then engaged with the second component 104 to complete the assembly. In this manner, a doghouse fastener 106 can accommodate two distinct spacing configurations without requiring multiple parts or adjustable hardware. This design provides reduced part count, increased modularity, and assembly efficiency, particularly beneficial in automotive, aerospace, and modular furniture applications.

The first component 102 may define an A-surface 102a and a B-surface 102b (illustrated as an undersurface). The A-surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a class B surface, is typically the surface that is not visible after assembly and typically includes various attachment devices and/or related features. In the illustrated example, the first component 102 defines a doghouse feature 116 on the B-surface 102b, while the second component 104 defines an opening 118.

The second component 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. The second component 104 may similarly define an A-surface 104a and a B-surface 104b (illustrated as an undersurface). Upon assembly, as best illustrated in FIG. 1b, the second component 104 is covered at least partially by the first component 102.

As illustrated, the doghouse feature 116 is attached to the B-surface 102b and, depending on the material type, may be attached to the B-surface 102b after fabrication of the first component 102 (e.g., using adhesive or a mechanical attachment method, such as the illustrated doghouse feature 116). While only a single doghouse feature 116 is illustrated in the examples, it should be appreciated that multiple doghouse features 116 may be used to couple a first component 102 to a second component 104, depending on the number of fastener points needed between the first component 102 and second component 104. For example, larger panels typically require multiple fastener points.

The doghouse fastener 106 is a generally rigid component that generally defines a doghouse head 106a and a fastener portion 106b extending along a center axis 110. In some examples, an umbrella 108 is positioned between the doghouse head 106a and the fastener portion 106b. The doghouse head 106a can be formed integrally with the fastener portion 106b and, where applicable, the umbrella 108.

The doghouse head 106a is configured to engage or otherwise attach to the first component 102. In the illustrated example, the doghouse head 106a generally defines a set of spaced-apart planar components (illustrated as first plate 112a and a second plate 112b) separated by a neck 114. In the illustrated embodiment, each of the first plate 112a and the second plate 112b is generally rectangular; however, one or both of the first plate 112a and the second plate 112b may alternatively be configured in other geometries, such as circular, oval, etc., depending on the desired application and/or shape of the doghouse feature 116. The dimensions and thickness of the disks may be adjusted to accommodate varying load requirements or space constraints.

The illustrated doghouse head 106a therefore comprises the first plate 112a and the second plate 112b, connected by the neck 114 to define a gap between the first plate 112a and the second plate 112b. The neck 114 extends between and integrally connects the first plate 112a to the second plate 112b. The illustrated neck 114 is cylindrical and ensures spacing between the first plate 112a to the second plate 112b to accommodate features of the first component 102, such as the doghouse feature 116. The neck 114 is aligned along the center axis 110, which also serves as the central axis for the overall doghouse fastener 106.

During assembly, a portion of the doghouse head 106a can be slid or slipped into a pocket 120 via slot 128 defined by the doghouse feature 116. In the illustrated example, the doghouse head 106a can be moved in the direction indicated by arrow 122 into the pocket 120. The slot 128 can be described as a keyhole shape and generally comprises a substantially circular neck hold section 128a and a tapered guide section 128b that guides the neck 114 toward and into the neck hold section 128a. For example, the first plate 112a and the second plate 112b are sized and shaped such that the second plate 112b fits in the pocket 120. The cylindrical geometry of the neck 114 also allows for a degree of alignment during installation.

The fastener portion 106b is configured to engage or otherwise attach to the second component 104. The fastener portion 106b is configured to attach to the second component 104, embed in the second component 104, or pass through at least a portion of the second component 104 (e.g., via the opening 118). The opening 118 formed in the second component 104 defines a size and shape that is complementary to that of the fastener portion 106b such that the fastener portion 106b can be inserted and retained therein. In an example, the opening 118 can be generally circular (e.g., a round hole) and/or a slot (e.g., a narrow, rectangular opening).

The illustrated fastener portion 106b comprises a mechanical fastener assembly 124 with a lead-in nose 126. The lead-in nose 126 can be tapered to facilitate the insertion of a distal end of the fastener portion 106b of the doghouse fastener 106 into the opening 118 of the second component 104. The lead-in nose 126 serves as a guide for the fastener during engagement.

When assembled, the umbrella 108 is positioned between the first component 102 and second component 104 as illustrated in FIG. 1b. In some examples, the doghouse fastener 106 may include a seal to mitigate dust, dirt, and/or moisture penetration through the opening 118. The seal may be embodied as a ring (e.g., an annular structure) and fabricated from foam material, thermoplastic, rubber, etc. For example, the seal can be over molded onto, or otherwise attached to, the umbrella 108 or a seal can be configured to fit over the distal end of the doghouse fastener 106 to surround a portion of the doghouse fastener 106 (e.g., adjacent the umbrella 108) between the first component 102 and the second component 104. In some examples, the doghouse fastener 106 may include additional features, such as ribs and wings to mitigate noise and/or rattle between the first and second components 102, 104.

While it is contemplated that the doghouse fastener 106 would be manufactured as an integral component via a plastic injection molding process, other materials and/or processes are contemplated, such as additive manufacturing techniques. Using additive manufacturing techniques, components can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the doghouse fastener 106 may be fabricated with the first component 102 using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., the higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the first component 102 and the doghouse fastener 106 may be formed or otherwise fabricated at different resolutions during a printing operation. For example, the doghouse fastener 106 portion may be printed at a higher resolution than that of the first component 102 or vice versa as needed for a particular application.

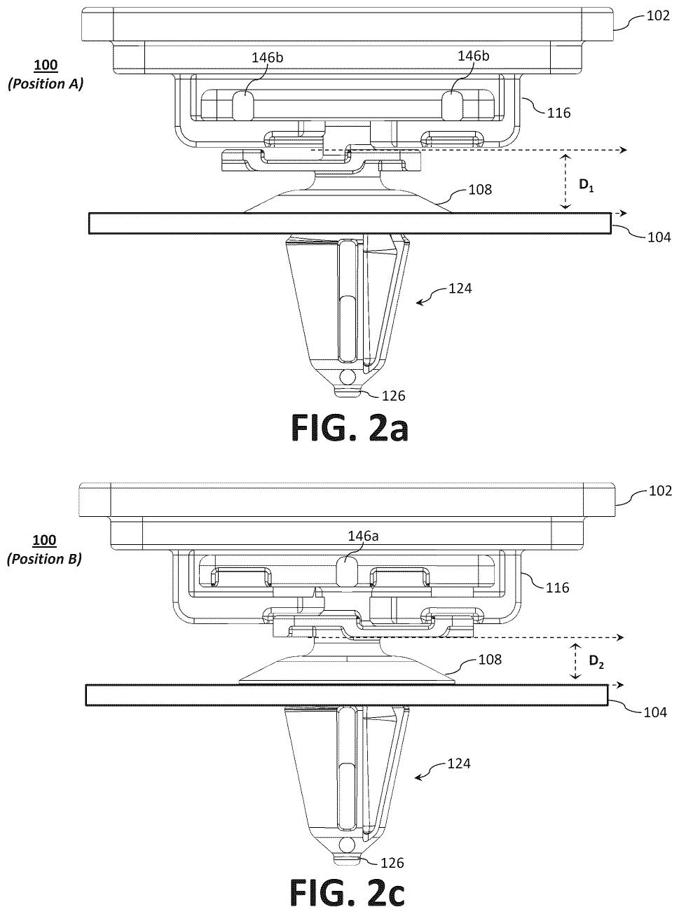

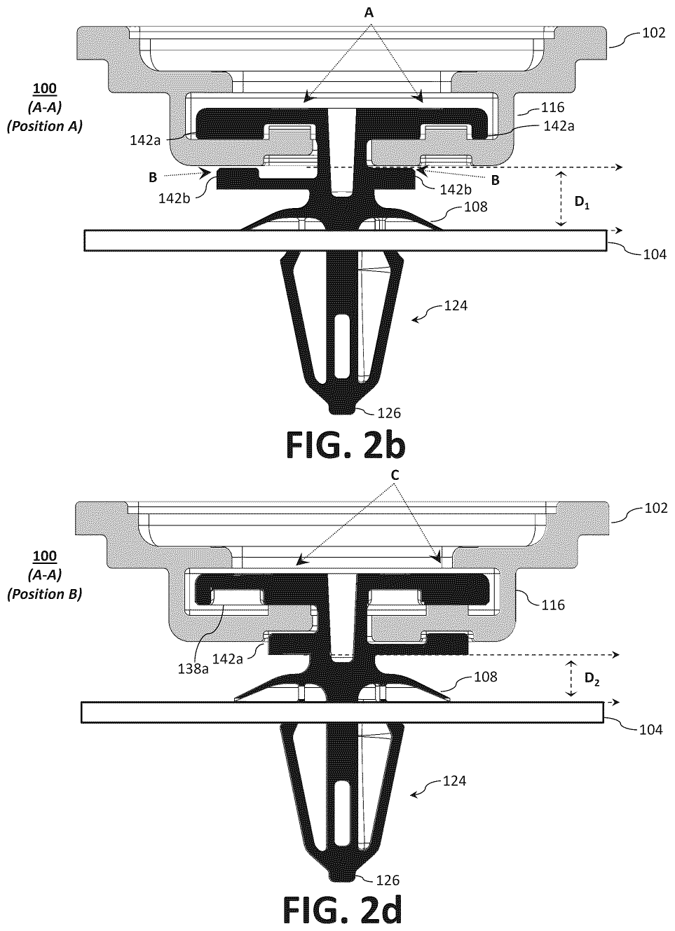

FIGS. 2a and 2b illustrate, respectively, side elevational and side cross sectional views of the fastening system 100 in a first installed orientation to provide a first spacing (D₁), while FIGS. 2c and 2d illustrate, respectively, side elevational and side cross sectional views of the fastening system in a second installed orientation to provide a second spacing (D₂).

The doghouse fastener 106 is configured for use in an adjustable spacing system to selectively provide either a first spacing (D1) or a second spacing (D2) between the first component 102 and a second component 104, such as a mating panel, vehicle body frame, or structural substrate. The doghouse head 106a is configured to be received within a doghouse feature 116 in one of two orientations by rotating the doghouse fastener 106 about the center axis 110 by 180 degrees. To provide the change in axial height, the doghouse head 106a is geometrically asymmetric along the lateral axis 130, which is perpendicular to the axis of insertion (arrow 122) and to the center axis 110.

In an example, the doghouse head 106a comprises a generally elongate body along the lateral axis 130 with a primary insertion surface 132a (e.g., a first edge) and an opposing secondary insertion surface 132b (e.g., a second edge). As such, when the doghouse head 106a is inserted into the doghouse feature 116 in a first installed orientation (Position A), the primary insertion surface 132a faces the back wall of the pocket 120 such that it is inserted first, thereby yielding the first spacing (D₁). When the doghouse head 106a is rotated 180 degrees about center axis 110 and inserted in a second installed orientation (Position B) where the secondary insertion surface 132b faces the back wall of the pocket 120 such that it is inserted first, resulting in the second spacing (D₂). This dual-orientation spacing capability is enabled by the asymmetric features of the doghouse head 106a and the pocket 120 of the doghouse feature 116, which is configured to receive the doghouse head 106a regardless of orientation.

The doghouse feature 116 defines the pocket 120, which is sized and shaped to receive the doghouse head 106a through a linear, unidirectional sliding motion indicated by arrow 122. Specifically, the pocket 120 includes parallel sidewalls 116a, 116b, a bottom wall 116c, and, in some cases, a back wall 116d. As illustrated, the parallel sidewalls 116a, 116b and spaced apart and bridged by a bottom wall 116c to define the pocket 120.

Insertion of the doghouse head 106a into the doghouse feature 116 may be guided by alignment rails 134 and alignment channels 140 configured to mate with complementary features formed on the doghouse head 106a, such as alignment head rails 142a, 142b and alignment channels 138a, 138b. Notably, the alignment rails 134 and alignment channels 140 allow the doghouse head 106a to be inserted in either the first installed orientation (Position A) or the second installed orientation (Position B) to adjust spacing between the first spacing (D₁) and the second spacing (D₂). The insertion motion (arrow 122) is generally aligned substantially normal or perpendicular to the major face of the first component 102.

The doghouse fastener 106 comprises two primary components: a doghouse head 106a and a fastener portion 106b. The fastener portion 106b is fixedly or integrally coupled to the doghouse head 106a. The fastener portion 106b may include any suitable form of mechanical fastener assembly 124.

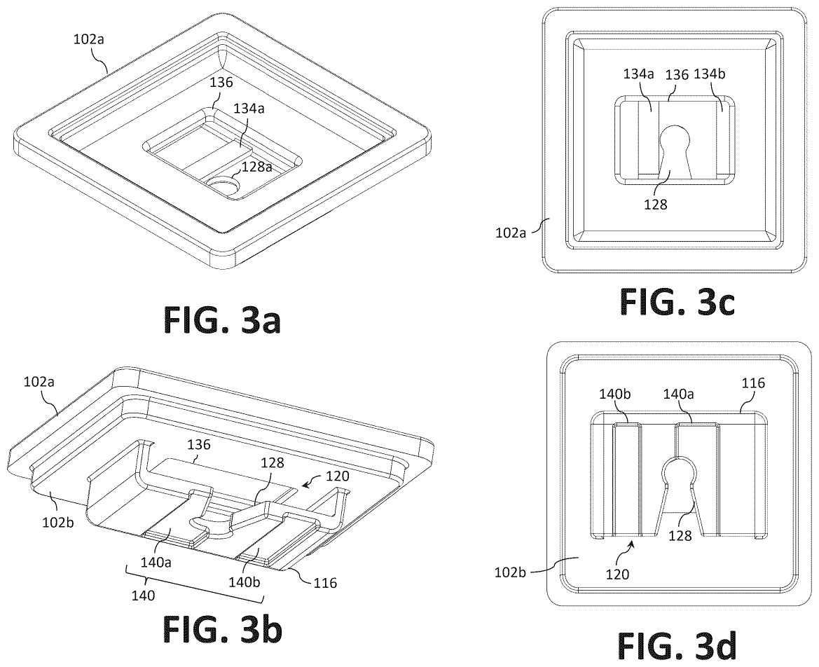

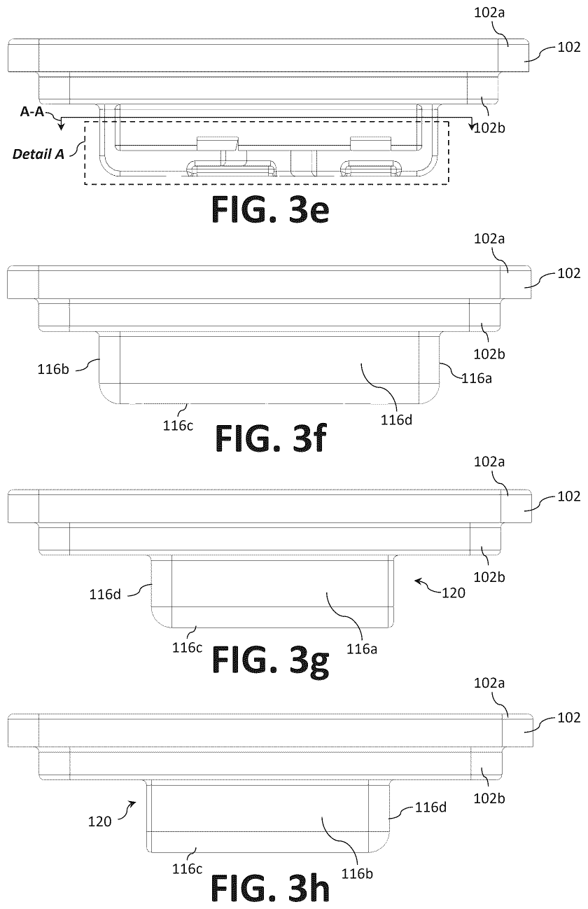

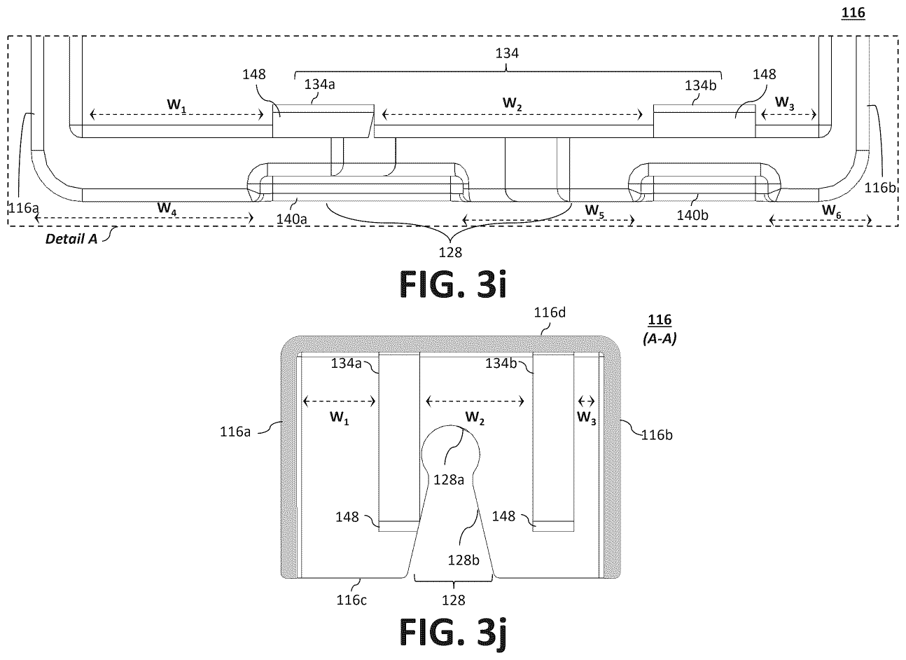

FIGS. 3a and 3b illustrate, respectively, topside and underside isometric views of the first component 102 with a doghouse feature 116. FIGS. 3c and 3d illustrate, respectively, top and bottom plan views of the first component 102. FIGS. 3e through 3h illustrate first, second, third, and fourth elevational side views of the first component 102. FIG. 3i illustrates an enlarged side view of the first component 102 at Detail A (FIG. 3e), while FIG. 3j illustrates a cross-sectional view of the first component 102 taken along cut line A-A (FIG. 3e).

With reference to FIGS. 3i and 3j, the pocket 120 comprises two parallel alignment rails 134a, 134b formed on the interior surface of the bottom wall 116c. The two illustrated alignment rails 134a, 134b are the same width. The illustrated first and second alignment rails 134a, 134b are asymmetrically positioned laterally (i.e., along the lateral axis 130). Specifically, the first alignment rail 134a is spaced from an interior surface of the first sidewall 116a by a first width (W₁), and the first rail 134a is spaced from the second alignment rail 134b by a second width (W₂), and the second alignment rail 134b is spaced from an interior surface of the first sidewall 116a by a third width (W₃). Each of the first, second, and third widths (W₁, W₂, W₃), may be different (i.e., not equal). In the illustrated example, the second width (W₂) is greater than the first width (W₁), which, in turn, is greater than the third width (W₃). Each of the alignment rails 134a, 134b can include a ramped end 148 to guide the doghouse head 106a during insertion into the pocket 120.

The opposite side of the bottom wall 116c (i.e., the exterior surface) comprises two parallel alignment channels 140. The illustrated first and second alignment channels 140a, 140b are asymmetrically positioned laterally. The two illustrated alignment channels 140a, 140b are different widths. Specifically, the first alignment channel 140a is spaced from an exterior surface of the first sidewall 116a by a fourth width (W₄), and the first rail 140a is spaced from the second alignment channel 140b by a fifth width (W₅), and the second alignment channel 140b is spaced from an exterior surface of the first sidewall 116a by a sixth width (W₆). Each of the fourth, fifth, and sixth widths (W₄, W₅, W₆), may be different (i.e., not equal). In the illustrated example, the fourth width (W₄) is greater than the fifth width (W₅), which, in turn, is greater than the sixth width (W₆).

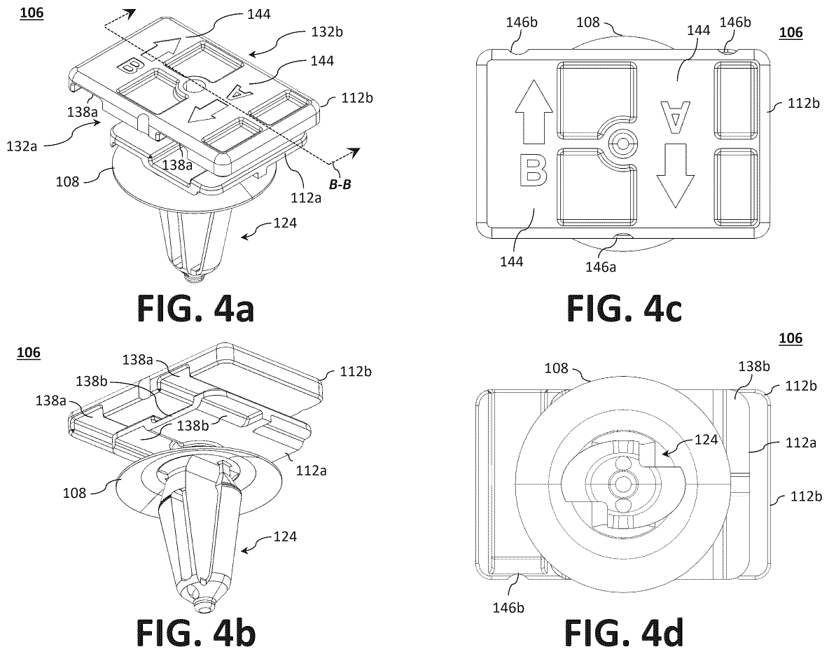

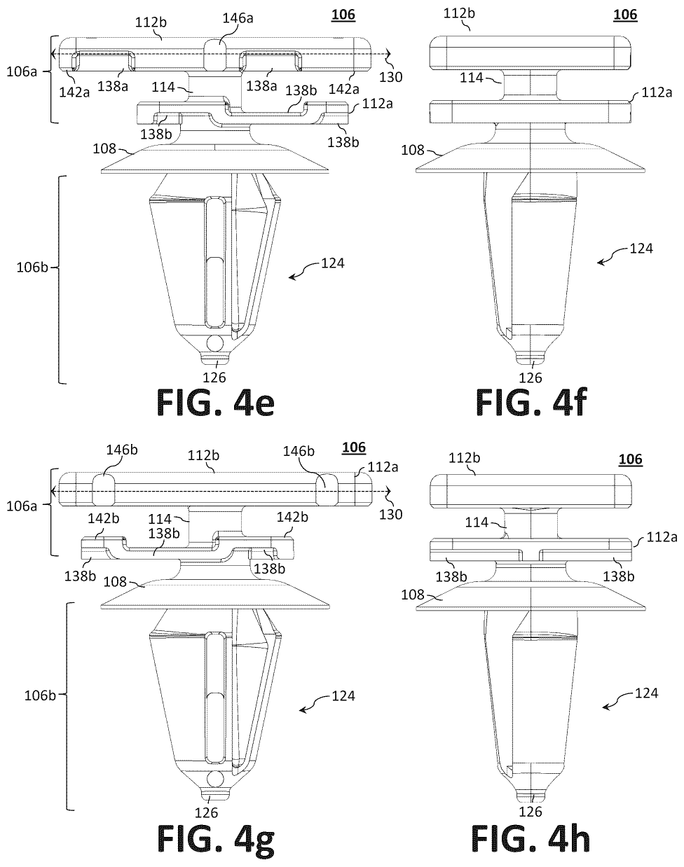

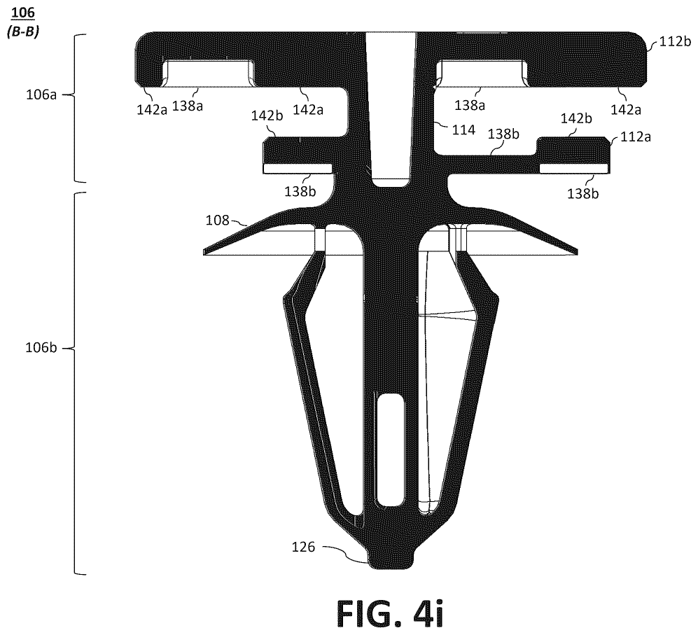

FIGS. 4a and 4b illustrate, respectively, topside and underside isometric views of the doghouse fastener 106. FIGS. 4c and 4d illustrate, respectively, top and bottom plan views of the doghouse fastener 106. FIGS. 4e through 4h illustrate first, second, third, and fourth elevational side views of the doghouse fastener 106. FIG. 4i illustrates a cross-sectional view of the doghouse fastener taken along cut line B-B (FIG. 4e).

The doghouse head 106a comprises a plurality of features configured to mate with the doghouse feature 116 and, based on the desired installed orientation (Position A or Position B), assume either the first spacing (D₁) or the second spacing (D₂).

With reference to FIG. 4i, the first plate 112a comprises a plurality of alignment head channels 138b and alignment head rails 142a, while the second plate 112b comprises a plurality of alignment head channels 138a and alignment head rails 142b. In the illustrated example, the alignment head channels 138b, the alignment head rails 142a, the alignment head channels 138a, and alignment head rails 142b are linear and substantially parallel to one another. Further, as illustrated, while the second plate 112b is centered relative to the neck 114, the first plate 112a is offset such that the neck 114 is not centered relative to the first plate 112a.

The plurality of alignment head channels 138b and alignment head rails 142a interface with the plurality of alignment head channels 138a and alignment head rails 142b differently depending on the installed orientation. With reference to FIG. 2b, when installed in a first installed orientation (Position A), the alignment head channels 138b and alignment head rails 142b align (see contact points A) such that the alignment head rails 142b is received in the alignment head channels 138b, thus decreasing the component distance to achieve the first spacing (D₁). Further, alignment head rails 142b abut the exterior surface of the bottom wall 116c of the doghouse feature 116 to maintain the first spacing (D₁). Conversely, with reference to FIG. 2d, when installed in a second installed orientation (Position C), the alignment head rails 142a and alignment head rails 142b align such that the alignment head rails 142b abuts and rests upon the alignment head rails 142a (see contact points B), thus increasing the component distance to achieve the second spacing (D₂). Further, alignment head rails 142b reside in the first and second alignment channels 140a, 140b of the doghouse feature 116 to maintain the second spacing (D₂).

The illustrated first plate 112a comprises first and second alignment head rails 142b asymmetrically positioned laterally on the surface facing the second plate 112b. As illustrated, a first alignment head rail 142b is positioned adjacent to the neck 114, while the second alignment head rail 142b is spaced from the neck 114 by a distance, with an alignment head channel 138b positioned therebetween. The illustrated first plate 112a also comprises first and second alignment head channels 138b asymmetrically positioned laterally on the surface facing away from the second plate 112b. As illustrated, the first alignment head channel 138b is positioned adjacent the neck 114, while the second alignment head channel 138b is spaced from the neck 114 by a distance.

The illustrated second plate 112b comprises first, second, and third alignment head rails 142b asymmetrically positioned laterally on the surface facing the first plate 112a. In this example, the first and second alignment head rails 142b are positioned on the first side of the neck 114, and the third alignment head rail 142b is positioned on the second side of the neck 114, opposite the first side.

As illustrated, a first alignment head rail 142b is positioned at an edge of the second plate 112b; a second alignment head rail 142b is positioned adjacent the neck 114 and spaced from the first alignment head rail 142b by an alignment head channel 138a. The third alignment head rail 142b is positioned at the opposite edge of the second plate 112b and spaced from the neck 114 by a distance, with an alignment head channel 138a positioned therebetween.

To facilitate correct and intentional orientation of the doghouse head 106a during installation, the doghouse fastener 106 optionally comprises one or more visual orientation indicators 144 (or other indicia) to identify, or distinguish, the primary insertion surface 132a and the opposing secondary insertion surface 132b.

Example indicators 144 include, for example, arrows, symbols, alphanumeric characters, or color-coded zones. The one or more visual orientation indicators 144 can be positioned on the surface of the second plate 112b facing away from the first plate 112a. For example, with reference to FIG. 4c, a first directional arrow and a second directional arrow may be embossed or printed on a surface of the second plate 112b, pointing in the direction of insertion when the first installed orientation (Position A), e.g., small spacing mode, is desired, and, when the doghouse fastener 106 is rotated, pointing in the direction of insertion for the second installed orientation (Position B), e.g., large spacing mode. Alternatively, or additionally, indicia such as “HIGH” and “LOW” may be included on the respective faces to indicate the spacing state. Further, symbols such as a triangle or square may correspond to specific installation tools or assembly instructions. These visual cues aid the user in selecting the correct orientation prior to insertion, without requiring measurement tools or complex alignment mechanisms. While the indicators 144 are generally described as being installed on or associated with the second plate 112b, it is also contemplated that they may instead be installed on the first plate 112a. For example, the indicators 144 could be formed along one or more edges of the first plate 112a.

With reference to FIG. 3c, a window 136 can be provided above the doghouse feature 116 (e.g., aligned with the bottom wall 116c) to enable the user to view the one or more visual orientation indicators 144 once installed. The window 136 can be formed in, for example, the first component 102.

In another example, the visual orientation indicators 144 (can be provided in the form of dimples 146a, 146b or other physical landmarks positioned on the primary insertion surface 132a and the opposing secondary insertion surface 132b. With referent to FIGS. 2a and 2c, positioning the visual orientation indicators 144 on the edge of the second plate 112b (e.g., one the primary insertion surface 132a and/or the opposing secondary insertion surface 132b) enables a user to confirm visually and tactilely the orientation post-assembly.

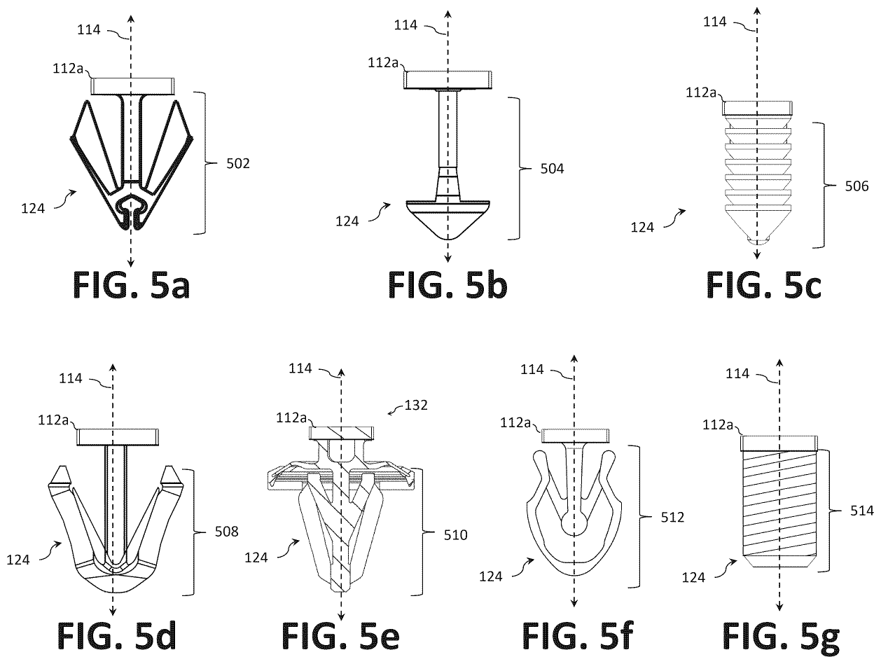

FIGS. 5a through 5g illustrate additional doghouse fastener 106 styles for coupling with the component in accordance with other aspects of this disclosure. While the doghouse fastener 106 is illustrated in the figures with a particular mechanical fastener assembly 124, other fastener designs for the mechanical fastener assembly 124 are contemplated. Specifically, FIGS. 5a through 5g illustrate, respectively, a W-shaped clip fastener 502 (illustrated as a 2-legged clip fastener), pin fastener 504, a push-pin fastener 506 (illustrated as a 2-legged box-prong fastener), a specialty attachment assembly 508 (e.g., a CenterLok™ fastener, which is available from Deltar®), an attachment assembly with four retaining legs 510, an attachment assembly with two snap-engaging seats 512, and a threaded shank 514 (e.g., a threaded stud). The attachment assembly with four retaining legs 510, which is illustrated in FIG. 5e as a cross-sectional view, is further described in connection with commonly owned U.S. Pat. No. 10,385,901 to Jeffrey J. Steltz. The attachment assembly with two snap-engaging seats 512 of FIG. 5f is further described in connection with commonly owned U.S. Pat. No. 10,018,214 to Fulvio Pacifico Yon. Other suitable fastening techniques that can be used include, for example, threaded fasteners, quarter turn fastener, etc.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A doghouse fastener for forming a connection between a first component having a doghouse feature and a second component, the doghouse fastener comprising:
a retention portion configured to engage the second component; and
a doghouse head integrally formed with the retention portion and configured to slide into the doghouse feature along an axis to assume selectively one of:
a first installed orientation to provide a first spacing between the first component and the second component; and
a second installed orientation to provide a second spacing between the first component and the second component,
wherein the doghouse head comprises a first plate connected to a second plate by a neck to define a gap between the first plate and the second plate.

2. The doghouse fastener of claim 1, wherein at least one the first plate and the second plate are geometrically asymmetric along a lateral axis.

3. The doghouse fastener of claim 1, wherein the doghouse head comprises a primary insertion surface associated with the first installed orientation and a secondary insertion surface associated with the second installed orientation, wherein the primary insertion surface and the secondary insertion surface are positioned on opposite sides of the doghouse head.

4. The doghouse fastener of claim 3, wherein inserting the primary insertion surface first into the doghouse feature results in the first installed orientation, and inserting the secondary insertion surface first into the doghouse feature results in the second installed orientation.

5. The doghouse fastener of claim 3, wherein doghouse head is rotated about its center axis to alternate between the first installed orientation and the second installed orientation.

6. The doghouse fastener of claim 1, wherein the neck is offset relative to the first plate and centered relative to the second plate.

7. The doghouse fastener of claim 1, wherein at least one of the first plate and the second plate comprises at least one alignment head channel and at least one alignment head rail configured to interface with at least one alignment channel and at least one alignment rail associated with the doghouse feature.

8. The doghouse fastener of claim 7, wherein the at least one alignment head channel is configured to receive the at least one alignment rail when in the first installed orientation.

9. The doghouse fastener of claim 7, wherein the at least one alignment head rail is configured to abut the at least one alignment rail when in the second installed orientation.

10. The doghouse fastener of claim 3, wherein the second plate comprises one or more visual orientation indicators to identify the primary insertion surface or the secondary insertion surface.

11. A doghouse fastener assembly for forming a connection between a first component and a second component, the doghouse fastener assembly comprising:
a doghouse feature associated with the first component,
wherein the doghouse feature comprises a set of sidewalls bridged by a bottom wall to define a pocket; and
a doghouse fastener having a retention portion configured to engage the second component and a doghouse head integrally formed with the retention portion and configured to engage the doghouse feature,
wherein the doghouse head comprises a first plate connected to a second plate by a neck to define a gap between the first plate and the second plate, and
wherein the doghouse head is configured to slide along an axis and into the pocket selectively in one of:
a first installed orientation to provide a first spacing between the first component and the second component; and
a second installed orientation to provide a second spacing between the first component and the second component.

12. The doghouse fastener assembly of claim 11, wherein the doghouse head comprises a primary insertion surface associated with the first installed orientation and a secondary insertion surface associated with the second installed orientation, wherein the primary insertion surface and the secondary insertion surface are positioned on opposite sides of the doghouse head.

13. The doghouse fastener assembly of claim 12, wherein inserting the primary insertion surface first into the pocket results in the first installed orientation, and inserting the secondary insertion surface first into the pocket results in the second installed orientation.

14. The doghouse fastener assembly of claim 12, wherein doghouse head is rotated about its center axis to alternate between the first installed orientation and the second installed orientation.

15. The doghouse fastener assembly of claim 11, wherein the neck is offset relative to the first plate and centered relative to the second plate.

16. The doghouse fastener assembly of claim 11, wherein the bottom wall comprises a keyhole-shaped slot.

17. The doghouse fastener assembly of claim 11,
wherein the bottom wall comprises at least one alignment channel and at least one alignment rail, and
wherein at least one of the first plate and the second plate comprises at least one alignment head channel and at least one alignment head rail configured to interface with the at least one alignment channel and the at least one alignment rail.

18. The doghouse fastener assembly of claim 17, wherein the at least one alignment head channel is configured to receive the at least one alignment rail when in the first installed orientation.

19. The doghouse fastener assembly of claim 17, wherein the at least one alignment head rail is configured to abut the at least one alignment rail when in the second installed orientation.

20. The doghouse fastener assembly of claim 12, wherein the second plate comprises one or more visual orientation indicators to identify the primary insertion surface or the secondary insertion surface.
